(19) United States
(12) Patent Application Publication
(10) Pub. No.: US 2002/0197372 A1
(43) Pub. Date: Dec. 26, 2002

(54) Solid mixture consisting of foodstuff ingredients and foodstuff additives, method for the production thereof and their use

(76) Inventors: Evelyn Janssen, Frankfurt (DE); Ralf Schmidt, Frankfurt (DE)

Correspondence Address: Klaus Schweitzer, ProPat, Crosby Building, 2912 Crosby Road, Charlotte, NC, 28211-2815, US

(21) Appl. No.: 10/148,941

(22) PCT Filed: Dec. 9, 2000
(86) PCT No.: PCT/EP00/12468

(30) Foreign Application Priority Data
Dec. 17, 1999 (DE) 199 61 338.9

(51) Int. Cl. A23L 1/236

(52) U.S. Cl. 426/548

(57) ABSTRACT

The invention relates to a solid mixture consisting of foodstuff ingredients and foodstuff additives, whereby the mixture is comprised of at least one thermoplastic deformable matrix material and of at least one food stuff additive that is incorporated in said matrix material.

The invention relates to solid mixtures of food ingredients and food additives, a process for production thereof and use thereof.

Food additives are substances which are intended to be added to foods to affect their qualities or to achieve certain properties or effects. The present invention relates to such food additives, but also to more indirect substances counted among food ingredients or food additives. Generally, the invention therefore relates, for example, to intense sweeteners such as aspartame, alitame, neotame, acesulfame-K, saccharin, cyclamate, sucralose, thaumatin, neohesperidin dihydrochalcone (NHDC), neotame and steviosides and to combinations of these sweeteners and combination salts or sugar substitutes and sugars such as xylitol, erythritol, sorbitol, maltitol, Isomalt, mannitol, lactol and fructose, sucrose, glucose, lactose. D-tagatose or acids such as citric acid, malic acid, tartaric acid, fumaric acid, phosphoric acid, or oligosaccharides such as oligofructose, inulin, galactooligosaccharide, isomaltooligosaccharide, xylooligosaccharide, lactosucrose, glycosylsucrose, maltotetrose, maltodextrins or maltose.

Such food ingredients and food additives are used in foods in part alone, but more frequently as mixtures of various substances. The mixtures are either produced directly from the corresponding individual components at the food producer or manufacturer's premises, or mixed in the desired ratios at the food additive manufacturer's premises or at a corresponding further processor's premises, and are then provided to the food producer. A disadvantage of such mixtures is that the various components separate with time, owing to their different particle sizes and/or specific gravities, and the mixtures thus become inhomogeneous.

It was an object of the present invention to provide mixtures of food ingredients and food additives which no longer separate even over a relatively long period and thus guarantee a constant mixing ratio.

This object is achieved by a solid mixture of food ingredients and food additives which consists of at least one thermoformable matrix material and at least one food additive incorporated into this matrix material.

Extrusion technology has long been known. In this technology, plasticizable substances are transported by means of a transport mechanism, for example a screw, from a feed apparatus to a die and on their way to it are plasticized. In many cases, considerable amounts of energy must be employed in order to plasticize generally solid substances. It has hitherto been assumed that these amounts of energy required for extrusion are too high for the usually highly sensitive food ingredients and food additives and that these decompose or are at least irreversibly damaged during the extrusion.

Surprisingly, it has now been found that certain food ingredients and food additives are either themselves thermoformable, that is to say can be processed by means of extrusion technology, or can be incorporated by means of extrusion technology into certain thermoformable matrix substances which are permitted under food legislation, without the food ingredients or food additives suffering irreversible damage during extrusion. Inventive food ingredients and food additives, regardless of whether they are thermoformable, are sweeteners such as aspartame, alitame, neotame, acesulfame-K, saccharin, cyclamate, sucralose, thaumatin, neohesperidin dihydrochalcone (NHDC), neotame and steviosides and combinations of these sweeteners and combination salts or sugar substitutes and sugars such as xylitol, erythritol, sorbitol, maltitol, Isomalt, mannitol, lactol and fructose, sucrose, glucose, lactose. D-tagatose or acids such as citric acid, malic acid, tartaric acid, fumaric acid, phosphoric acid, or oligosaccharides such as oligofructose, inulin, galactooligosaccharide, isomaltooligosaccharide, xylooligosaccharide, lactosucrose, glycosylsucrose, maltotetrose, maltodextrins or maltose, or dietary fibers such as plant fibers, or flavors or vitamins.

Thermoformable food ingredients and food additives are substances which occur in solid form and are flowable above the melting temperature. In the softened state, they can be processed by extrusion. The thermoformable matrix materials must themselves be harmless for the purposes of food legislation, preferably they themselves are a constituent of the food ingredient and food additive mixture. Thermoformable matrix materials which can be used are, for example: sweeteners such as cyclamate, sucralose or sugar substitutes and sugars such as xylitol, erythritol, sorbitol, mannitol, lactol and fructose, sucrose, glucose, lactose, D-tagatose, or acids such as citric acid, malic acid, tartaric acid, or oligosaccharides such as oligofructose, inulin, galactooligosaccharide, isomaltooligosaccharide, xylooligosaccharide, lactosucrose, glycosylsucrose, maltotetrose, maltodextrins, polydextrose or maltose.

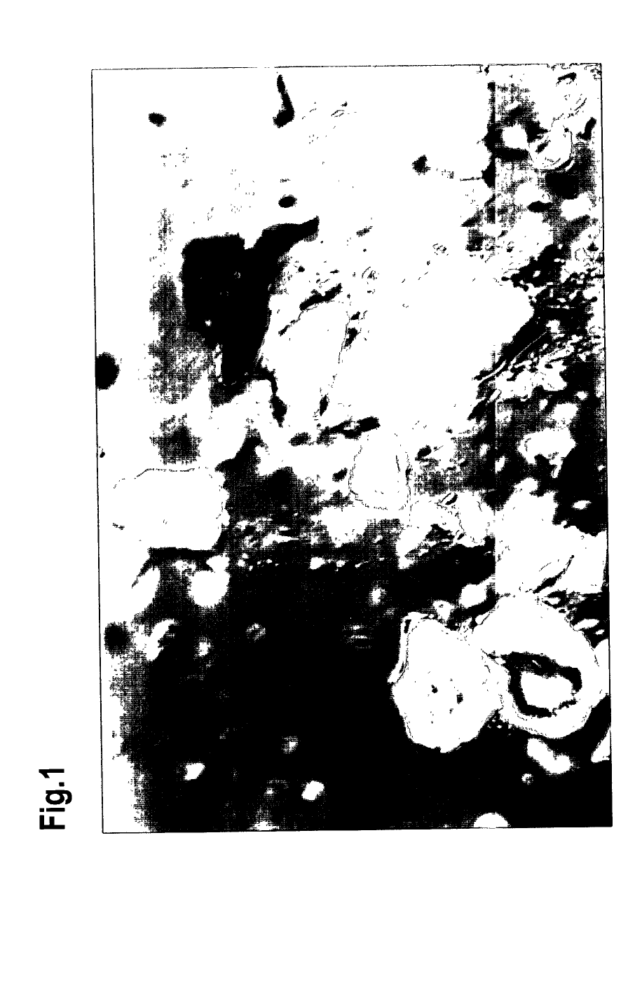

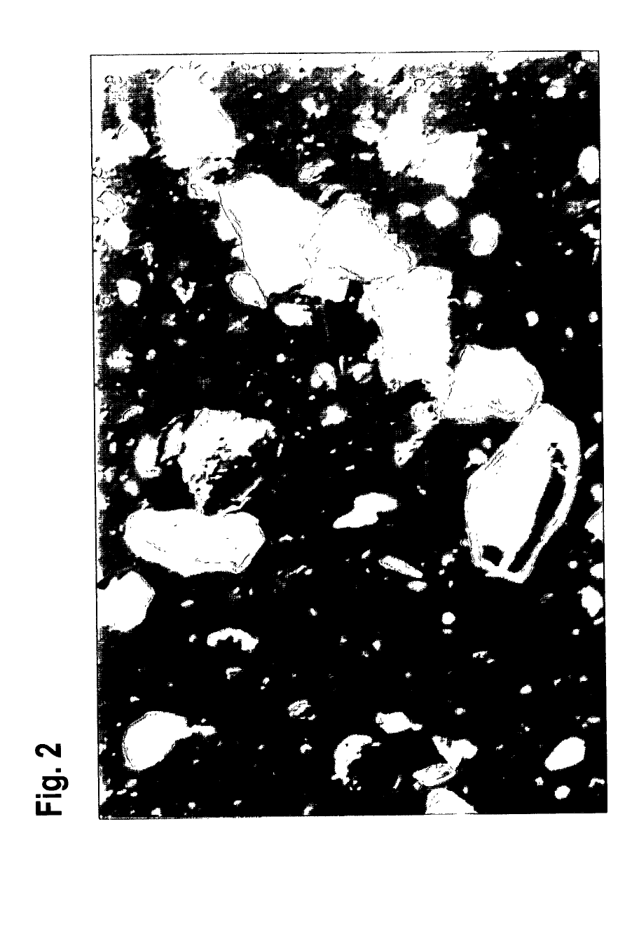

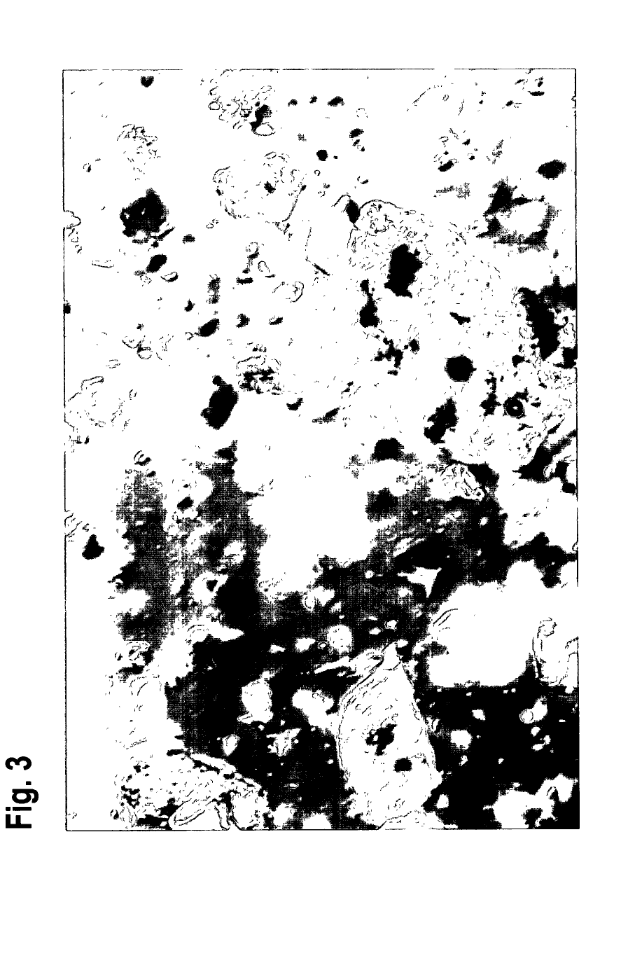

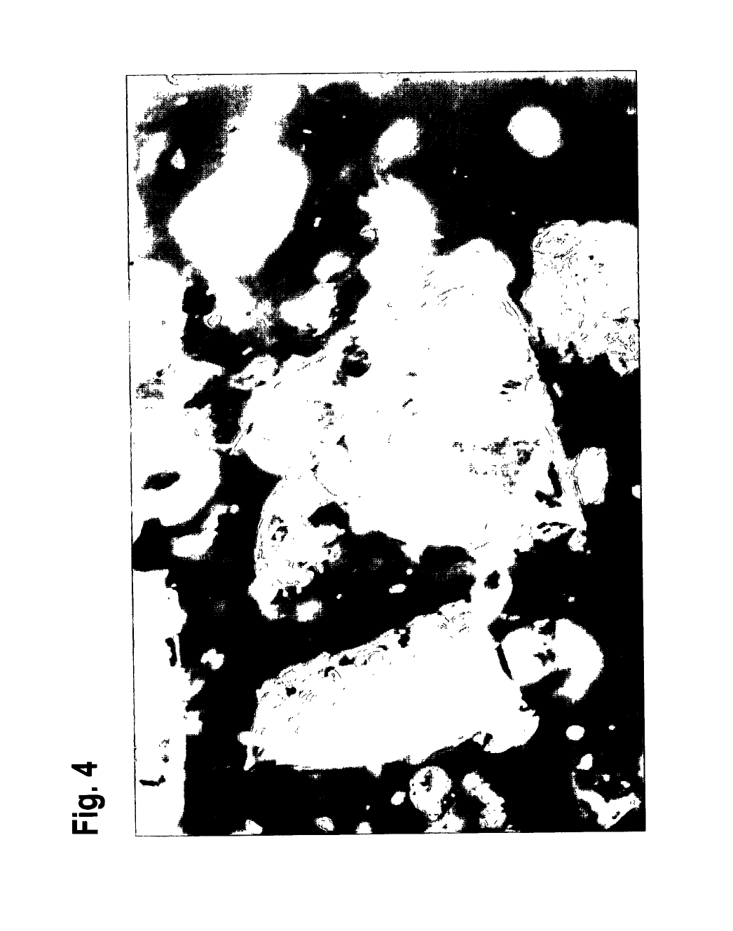

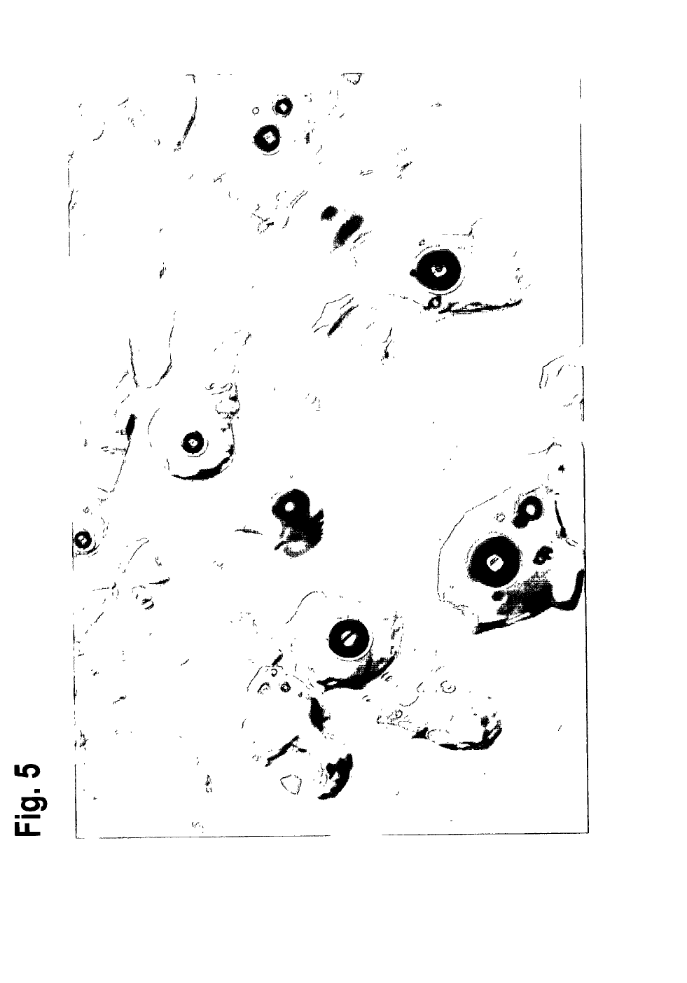

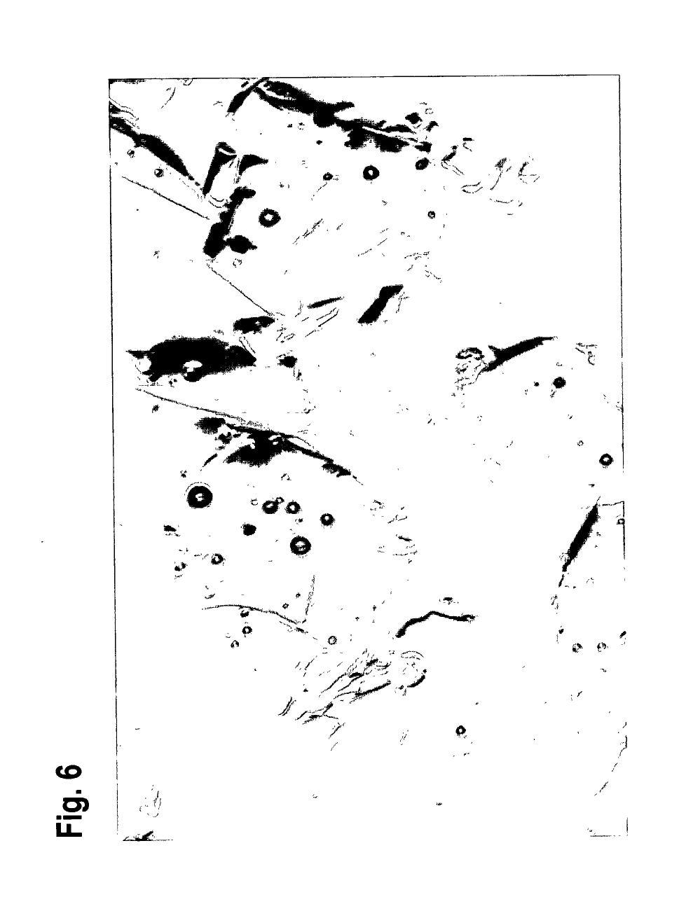

“Incorporated” for the purposes of the invention means that a discrete particle is separated by a phase boundary from another material (the matrix material) and is enclosed on all sides by this other material. In a section through the matrix material, by means of suitable methods, for example polarization microscopy, the discrete particles may be identified as quasi islands in the surrounding matrix (sea) (island in sea structure). Under polarization microscopy, the inventive “island in sea” structure may be identified in the comminuted particles of the solid mixture. Crystals present polarize the light, whereas the thermoformable amorphous matrix material does not polarize the light. FIGS. 1 to 6 illustrate this: FIG. 1 shows a powder mixture of acesulfame, aspartame and erythritol at 200× enlargement in differential interference contrast (DIC). Individual large and smaller crystals which polarize the light may be clearly seen. The same powder composition is the basis of FIG. 2; in addition a blue λ filter was used. Crystals of the individual components of the powder mixture may clearly be seen in the differing polarization of the light. In contrast to this, in FIG. 3, which is based on an extruded acesulfame/aspartame/erythritol mixture, particles which may clearly be identified as solidified melt may be seen; on the rough surface, small pores (black rings) may be seen. Incorporated in the melt are small crystals which polarize the light. FIG. 4 shows the same sample as FIG. 3, but using the blue λ filter. On the larger particles, relatively small inclusions may be seen that polarize the light. FIGS. 5 and 6 illustrate again the difference between a powder mixture and the inventive extrudate using an acesulfame/aspartame/inulin mixture. In FIG. 5 (powder mixture), inulin may be observed as solidified melt containing large pores (black rings) in addition to isolated sweetener crystals. In FIG. 6, the sweetener crystals now incorporated in the inulin may clearly be seen; the pores have become smaller.

Surprisingly, it has been found that the inventive mixtures in part have new properties which are expressed, for example, in a different solution behavior. Thus, some inventive mixtures of sweeteners with acids displayed an accelerated dissolution behavior, compared with the individual components, and other mixtures of sweetener with sucrose, sugars and sugar substitutes showed a delayed dissolution behavior compared with the individual components.

The inventive solid mixtures can be prepared using extrusion technology. Suitable equipment is all known and commercially available screw machines, in particular twin-screw machines with corotating screws and temperature-control facilities. The thermoformable matrix material is first mixed with the food ingredient(s) or additive(s). The materials are then processed in the screw machine. The pulverulent material is compressed and then continually plasticized and pressed out as a rod from a die. The resultant extrudates are then comminuted and brought to the desired particle size. As an alternative to mixing prior to being charged into the extruder, the individual components can also be fed separately to the extruder and only then mixed with one another in the extruder. Expediently, the extrusion is performed at 50-150° C. and a screw speed of 50-500 revolutions per minute.

The inventive mixtures fulfil the object set; there is no longer any separation, and the mixing ratios established are maintained over at least 2 years.

The invention is described in more detail below with reference to examples.

### EXAMPLES

Melt extrusion experiments were carried out using 7 different mixtures of sweeteners with differing support materials which have thermoplastic properties. For this purpose, firstly the individual components of the respective mixtures were mixed with one another in plastic packages by vigorous shaking by hand. The individual batches each weighed 1.5 kg.

A double-screw extruder was used for the extrusion process. The process parameters (melt temperature and screw speed) were first estimated roughly by preliminary trials. In the main experiment, extrusion products of the individual mixtures were produced using optimized process parameters in each case (see table 1).

The mixtures were ground using an impact cutter mill (model A 10, from Janke & Kunkel GmbH and Co. KG) at 20 000 rpm for 3 to 5 seconds. The ground products were screened into 2 fractions (>1 000 μm and <1 000 μm). Three random samples of the >1 000 μm fraction were each analyzed by HPLC for sweetener content. No aspartame degradation products were found. The order of magnitude of the amounts of acesulfame-K (Sunett®, Nutrinova Nutrition Specialties & Food Ingredients GmbH, Frankfurt am Main, Federal Republic of Germany) and aspartame found by analysis indicates that the sweeteners remain stable during melt extrusion.

The deviations of the individual random samples from the mean value are not very high, at a maximum of 4% (NHDC in mixture No. 6, table 1). Therefore, the individual components are highly uniformly distributed in the extrusion product.

The dissolution rate of the extruded mixtures in water were compared with the pulverulent nonextruded premixes (table 2).

The mixtures with citric acid as a carrier showed, compared with the powder premixes, approximately equal to markedly better solubility. In the case of the extrusion products using polyols as carrier, markedly longer dissolution times than with the powder premixes were observed.

TABLE 1

| No. | Composition | | Percentage | Note 1 | Note 2 |
|---|---|---|---|---|---|
| 1 | 1.050 kg | citric acid | 70% | Slight lump formation in the | Slight lump formation (atmospheric |
| | 0.135 kg | acesulfame-K | 9.0% | mixture (atmospheric humidity); | humidity); temperature approx. |
| | 0.315 kg | aspartame | 21.0% | at 100° C. clear slightly colored | 55° C.; screw speed 300 rpm; |
| | | | | liquid with slight foam | extrudate: white sticky mass (like |
| | | | | formation; discoloration | soft ice cream or fluffy marshmallow) |
| | | | | decreases with lower speed of | |
| | | | | rotation; apparently still-lower | |
| | | | | temperatures are favorable | |
| 2 | 1.000 kg | erythritol | 66.6% | Rapidly crystallizing | |
| | 0.250 kg | acesulfame-K | 16.6% | | |
| | 0.250 kg | aspartame | 16.6% | | |
| 3 | 1.000 kg | inulin | 66.6% | Vitreous, solid extrudate | |
| | 0.250 kg | acesulfame-K | 16.6% | | |
| | 0.250 kg | aspartame | 16.6% | | |
| 4 | 1.000 kg | sucrose | 66.67% | Free-flowing mixture; approx. | Temperature: 120° C.; screw speed |
| | 0.250 kg | acesulfame-K | 16.67% | 120° C. pasty brownish mass of | a) 150 rpm b) 300 rpm; extrudate: |
| | 0.250 kg | aspartame | 16.67% | low viscosity; temperatures are | a) brownish pasty mass, marked caramel |
| | | | | not maintained (kneading | odor; b) beige rod, caramel odor; |
| | | | | blocks) | excessive friction by kneading |
| | | | | | elements of the screw, other screws |
| | | | | | necessary |
| 5 | 1.000 kg | mannitol | 66.67% | Free-flowing mixture; approx. | Temperature: a) 130° C.; screw |
| | 0.250 kg | acesulfame-K | 16.67% | 130° C. pasty mass with separate | speed 300 rpm; extrudate: a) white rod, |
| | 0.250 kg | aspartame | 16.67% | liquid; approx. 130° C. foaming | edges tear in a brittle manner; |
| | | | | liquid which crystallizes | b) white rod, edges smoother than at |
| | | | | rapidly and is homogeneous | 130° C. |
| 6 | 1.000 kg | lactose | 66.67% | Free-flowing mixture; 100° C. | Temperature: 105° C.; screw |
| | 0.250 kg | acesulfame-K | 16.67% | minimum; very high viscosity | speed a) 150 rpm, b) 300 rpm; extrudate: |
| | 0.250 kg | aspartame | 16.67% | foam, slightly brown; | a + b pasty slightly brown mass, |
| | | | | temperatures are not maintained | slight caramel odor. |
| | | | | (strong friction); cooling | |
| | | | | times very short; foam | |
| | | | | structure retained to a slight | |
| | | | | extent; with longer residence | |
| | | | | times the mixture burns | |
| 7 | 1.000 kg | Na cyclamate | 72.99% | Free-flowing mixture; optimum | Temperature: 115° C.; screw |
| | 0.141 kg | acesulfame-K | 10.29% | approx. 110° C.; no visible | speed a) 150 rpm; b) 300 rpm; extrudate: |
| | 0.141 kg | aspartame | 10.29% | thermal degradation; heat-stable | a) white rod, edges fracture; white rod, |
| | 0.088 kg | saccharin | 6.42% | and speed-stable; becomes | edges fracture more intensely than with a) |
| | | sodium | | kneadable mass, therefore ideal | |
| | | | | for kneader equipment; after | |
| | | | | cooling rapidly becomes solid | |
| | | | | and porcelain-like (sound) | |
| 8 | 1.000 kg | citric acid | 66.67% | Same comments as for 1 apply; | Temperature: a) 70° C., b) 65° C., |
| | 0.260 kg | acesulfame-K | 17.33% | because of the sticky mixture, | c) 65° C. |
| | 0.230 kg | aspartame | 15.33% | feed problems occur and the | Screw speed 300 rpm |
| | 0.010 kg | NHDC | 0.67% | feed sticks together slightly | Extrudate: |
| | | | | | a) white, viscous, slightly foamy |
| | | | | | b) viscous rod-like mass |
| | | | | | b) viscous rod-like mass |
| | | | | | The temperature must be decreased |
| | | | | | further for the carrier citric acid. |
| 9 | 1.000 kg | xylitol | 66.67% | Readily extrudable; optimum | Temperature: 90° C.; screw speed a) |
| | 0.250 kg | acesulfame-K | 16.67% | temperature approx. 90° C.; | 150 rpm, b) 300 rpm; extrudate: |
| | 0.250 kg | aspartame | 16.67% | viscosity of the pasty | a + b white rod |
| | | | | extrudate depends directly on | |
| | | | | the screw speed; no | |
| | | | | discoloration of the extruder, | |
| | | | | that is to say no thermal | |
| | | | | degradation | |

TABLE 2
Solubility in comparison
between pulverulent mixture and extrudate

Dissolution time
in s (1 g/100 ml of water) 50 rpm

| | Pulverulent mixture | Extrudate |
|---|---|---|
| Example 1 | 2 min 03 s | 2 min 35 s |
| | (colorless solution) | (yellowish clear |
| | | solution) |
| Example 2 | 3 min 06 s | 5 min 09 s |
| | (see also FIGS. 1 | (see also FIGS. 3 |
| | and 2) | and 4) |
| Example 3 | Not completely soluble | Not completely soluble |
| | (see also FIG. 5) | (see also FIG. 6) |
| Example 5 | 1 min 40 s | 5 min 30 s |
| | (colorless solution) | (slightly yellowish |
| | | solution) |
| Example 7 | 1 min 35 s | 50 s |
| | (colorless solution) | (yellowish clear |
| | | solution) |
| Example 8 | 3 min 15 s | 1 min 35 s |
| | (colorless solution) | (slightly yellowish |
| | | solution) |
| Example 9 | 1 min 30 s | 5 min 50 s |
| | (colorless solution) | (colorless solution |

1. A solid mixture of food ingredients and food additives, the mixture consisting of at least one thermoformable matrix material and at least one food additive incorporated into this matrix material.

2. The mixture as claimed in claim 1, wherein the food additive is selected from the group consisting of: sweeteners such as aspartame, alitame, neotame, acesulfame-K, saccharin, cyclamate, sucralose, thaumatin, neohesperidin dihydrochalcone (NHDC), neotame and steviosides and combinations of these sweeteners and combination salts or sugar substitutes and sugars such as xylitol, erythritol, sorbitol, maltitol, Isomalt, mannitol, lactol and fructose, sucrose, glucose, lactose. D-tagatose or acids such as citric acid, malic acid, tartaric acid, fumaric acid, phosphoric acid, or oligosaccharides such as oligofructose, inulin, galactooligosaccharide, isomaltooligosaccharide, xylooligosaccharide, lactosucrose, glycosylsucrose, maltotetrose, maltodextrins or maltose.

3. The mixture as claimed in either claim 1 or 2, wherein the matrix material is selected from the group consisting of: thermoformable food additive, . . .

4. The mixture as claimed in one of claims 1 to 3, wherein the mixture has an accelerated solubility in water compared with the pulverulent nonextruded premix.

5. The mixture as claimed in one of claims 1 to 3, wherein the mixture has a delayed solubility in water compared with the pulverulent nonextruded premix.

6. A process for producing a mixture as claimed in claim 1, wherein a thermoformable matrix material is mixed with one or more food ingredients and additives and is plasticized in an extruder and is pressed out as extrudate from a die and then the resultant extrudate is comminuted.

7. The use of a mixture as claimed in claim 1 as additive to foods.
